(19) United States
(12) Patent Application Publication
(10) Pub. No.: US 2011/0103053 A1
(43) Pub. Date: May 5, 2011

(54) LED Lighting Device

(75) Inventors: Wei-Chun Chen, Taipei City (TW); Fang-Po Wang, Yonghe City (TW); Yao-I Wang, Jhonghe City (TW)

(73) Assignee: LEDTECH ELECTRONICS CORP., Sindian City (TW)

(21) Appl. No.: 12/764,299

(22) Filed: Apr. 21, 2010

(30) Foreign Application Priority Data
Nov. 2, 2009 (TW) 98137092

(51) Int. Cl. F21V 1/00; F21V 7/00; F21V 29/00

(52) U.S. Cl. 362/235; 362/296.01; 362/294

(57) ABSTRACT

The LED lighting device includes a tubular housing, a light emitting unit, and a reflector. The tubular housing has an accommodating space. The light emitting unit is disposed in the accommodating space and has a plurality of light emitting diodes. The reflector is disposed in the accommodating space and has a wing-shaped reflecting portion. The reflecting portion faces the light emitting unit for reflecting the light source emitted from the light emitting diodes to the lateral directions of the tubular housing. As a result, the light source can be converted to a specific direction. Compare to the fluorescent lamps, the present invention has higher illumination efficiency and a longer operating life. The volume of the lamps and the cost are saved.

### BACKGROUND OF THE INVENTION

1. Field of the Invention

The present invention relates to an LED lighting device. In particular, the present invention relates to an LED lighting device that has a lateral light source.

2. Description of Related Art

Most ice tanks still use fluorescent lamps therein for lighting at present. In the low temperature environment of the ice tank, it is difficult for the electrodes at two ends of the fluorescent lamp to generate electron emissions, for this reason high power fluorescent lamps are used to overcome the problem. However, the high power fluorescent lamp radiates high frequency electromagnetic interference (EMI), the high frequency EMI would destroy the sensitive apparatus near the high power fluorescent lamp. Moreover, the electrodes of fluorescent lamps are easily broken or burn out in the low temperature environment through vibration or wide temperature variation. The operating life of the fluorescent lamp in these environments is short to the point that maintenance is significant, thereby causing significant levels of replacement of the damaged or broken fluorescent lamps over short intervals. The illumination efficiency will decrease in the low temperature environments. Aside from this, or in addition, the light direction of the fluorescent lamp is radiative, so that a part of the light illumination is blocked by the inner wall of the ice tank, thereby reducing the inside brightness of the ice tank to a point approaching simple ineffectiveness. To increase the brightness, more fluorescent lamps are then used in the ice tank. Certainly, overall costs increase.

Effectively the same or nearly same fluorescent lamps are used in the items, such as art painting or other exhibits. The light direction of the fluorescent lamps is radiative, rather than lateral, so that there is not enough bright illumination for the art painting which is at one side of the fluorescent lamps. Thus, again, more fluorescent lamps are used to increase the brightness. This results in higher cost.

### SUMMARY OF THE INVENTION

One particular aspect of the present invention is the provision of an LED lighting device, which can provide a lateral light source for efficient or effective use. Compared to fluorescent lamps, the present invention has better illuminating efficiency, longer operating life, and, therefore, the volume of used lamps is less than occurs when fluorescent lamps are used—cost is also improved.

The LED lighting device includes a tubular housing, a light emitting unit, and a reflector. The tubular housing has an accommodating space. The light emitting unit is disposed in the accommodating space and has a plurality of light emitting diodes. The reflector is disposed in the accommodating space and has a chevron reflecting portion. The reflecting portion faces the light emitting unit for reflecting the light from the light emitting diodes to the lateral directions of the tubular housing:

The present invention has useful characteristics beyond fluorescent lights:

1. The reflector is disposed in the tubular housing and has the mentioned chevron reflecting portion, which faces the light emitting unit for reflecting the light source to the two lateral directions of the tubular housing. Thus, the light source is used efficiently and effectively. When compared with fluorescent lamps, the present invention is able to increase brightness rather than using more lamps. In this manner, the number or concentration of lamps can be reduced.

2. In comparison with fluorescent lamps, the light emitting diodes generate higher temperatures when operating. Thus, the illumination efficiency is not reduced in the low temperature environment. Moreover, there are no burned-out or broken electrodes. Thus operating life is increased significantly, and the costs are saved.

For further understanding of the present invention, reference is made to the following detailed description illustrating the embodiments and examples of the present invention. The description is for illustrative purpose only and is not intended to limit the scope of the claims which are the only full description of the scope of this invention.

### BRIEF DESCRIPTION OF THE DRAWINGS

FIG. 1 is a side view of the first embodiment of the LED lighting device of the present invention;

FIG. 2 is a perspective view of the first embodiment of part of the LED lighting device of the present invention

FIG. 3 is a side view of the second embodiment of the LED lighting device of the present invention;

FIG. 4 is a side view of the third embodiment of the LED lighting device of the present invention;

FIG. 5 is a side view of the fourth embodiment of the LED lighting device of the present invention;

FIG. 6 is a side view of the fifth embodiment of the LED lighting device of the present invention;

FIG. 7 is a side view of the sixth embodiment of the LED lighting device of the present invention;

FIG. 8 is a side view of the LED lighting device of the seventh embodiment of the present invention;

FIG. 9 is a side view of the LED lighting device of the eighth embodiment of the present invention;

FIG. 10 is a side view of the LED lighting device of the ninth embodiment of the present invention;

FIG. 11 is a schematic diagram showing the LED lighting device used in a ice tank; and

FIG. 12 is a schematic diagram showing the LED lighting device used in the exhibits.

### DETAILED DESCRIPTION OF THE PREFERRED EMBODIMENTS

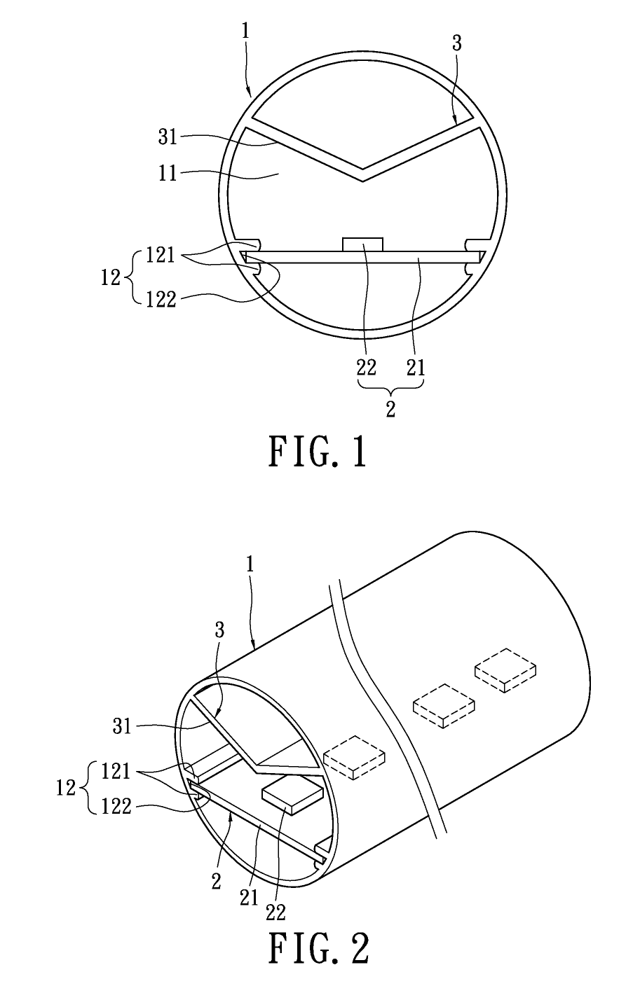

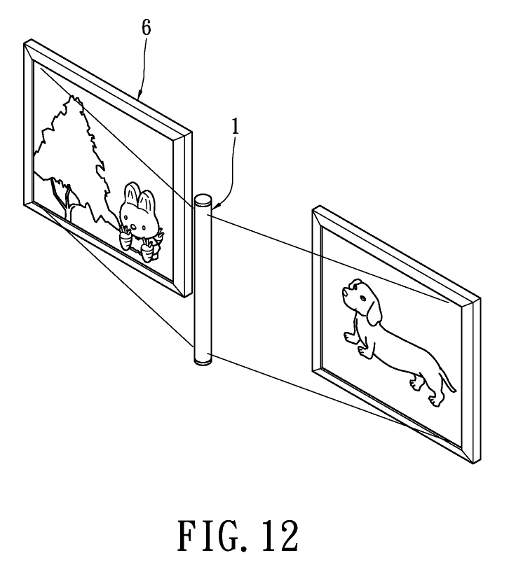

Reference is made to FIGS. 1 and 2. The LED lighting device can be used in an ice tank or wall painting (please refer to FIG. 11 and FIG. 12), includes a tubular housing 1, a light emitting unit 2, and a reflector 3.

In this embodiment, the tubular housing 1 is made of plastic, for example, including polycarbonate, acrylic or other appropriate materials. The tubular housing 1 is shaped into a transparent or translucent hollow column, but not limited to it. Compared to the tube of fluorescent lamp, the weight and the cost are reduced. The tubular housing 1 has an accommodating space 11 and an accommodating portion 12 therein. The accommodating portion 12 has four ribs 121, which protrude from and are disposed on the inner wall of the tubular housing 1 and have a face-to-face arrangement. An accommodating groove 122 is formed between two adjacent ribs 121 for disposing the light emitting unit 2 therein.

The light emitting unit 2 comprises an aluminum substrate 21 and a plurality of light emitting diodes 22. The aluminum substrate 21 is light weight and easy to dissipate heat. The aluminum substrate 21 is protruded from one end to the other end of the tubular housing 1. Two sides of the aluminum substrate 21 are located in the two accommodating grooves 122. The light emitting diodes 22 are disposed on the aluminum substrate 21 at intervals to provide the light source.

The reflector 3 is a bending board, which is disposed in the accommodating space 11 and protruded from one end to the other end of the tubular housing 1. The reflector 3 has a chevron (or wing-shaped) reflecting portion 31. The reflecting portion 31 faces the light emitting unit 2 and is located above the light emitting diodes 22 for reflecting the light source to the two sides of the tubular housing 1. In this embodiment, the reflector 3 and the tubular housing 1 are formed integrally via a double material injection molding.

In the other word, the tubular housing 1 can be made of a light-transmitting material, and the reflector 3 can be made of a light-reflecting material. The reflecting portion 31 is two sloping planes connected to each other, and the reflecting portion has a V-shaped cross section view. The reflecting portion 31 has an angle with 70 to 150 degrees, so that the light source has a better lateral reflection.

Reference is made to FIG. 3. In this embodiment, the reflector 3 and the tubular housing 1 are made of the same material. The reflecting portion 31 is a reflecting film, which is attached to the reflecting surface of the reflector 3. The reflecting surface of the reflector 3 faces the light emitting diodes 22.

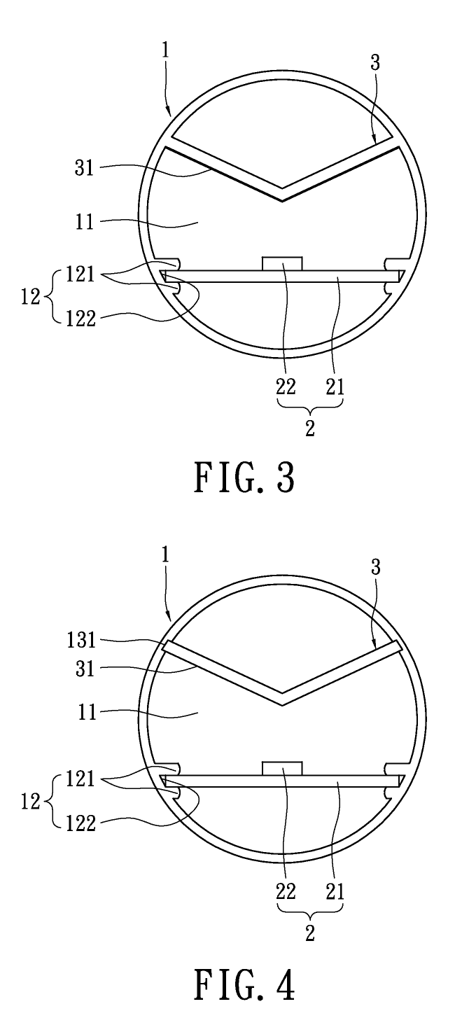

Reference is made to FIG. 4. The difference between this embodiment and the previous embodiment (FIG. 1) is described as followings. The inner wall of the tubular housing 1 has two opposing grooves 131, and the two ends of the reflector 3 are located in the two grooves 131.

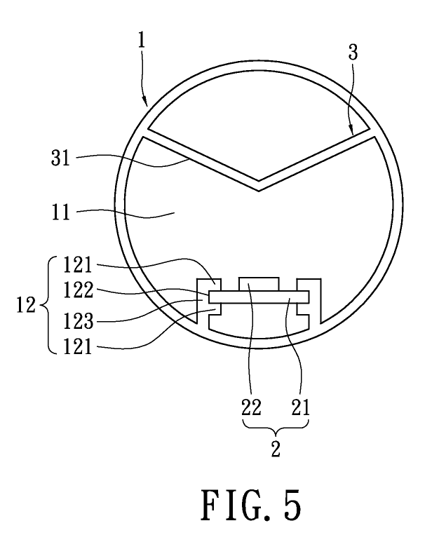

Reference is made to FIG. 5. The difference between this embodiment and the previous embodiment (FIG. 1) is described as followings. The accommodating portion 12 comprises two supporting portions 123 and four ribs 121. The two supporting portions 123 are protruded disposed on the inner wall of the tubular housing 1 and protruded from one end to the other end of the tubular housing 1. The four ribs 121 are protruded disposed on the inner wall of the two supporting portions 123 and have a face-to-face arrangement. The distance between the two accommodating grooves 122 is reduced, so that the area disposed between the two accommodating grooves 122 of the aluminum substrate 21 is reduced. As a result, the area that light source emitting out is increased. The shadow area generated by the light source covered by the aluminum substrate 21 is reduced.

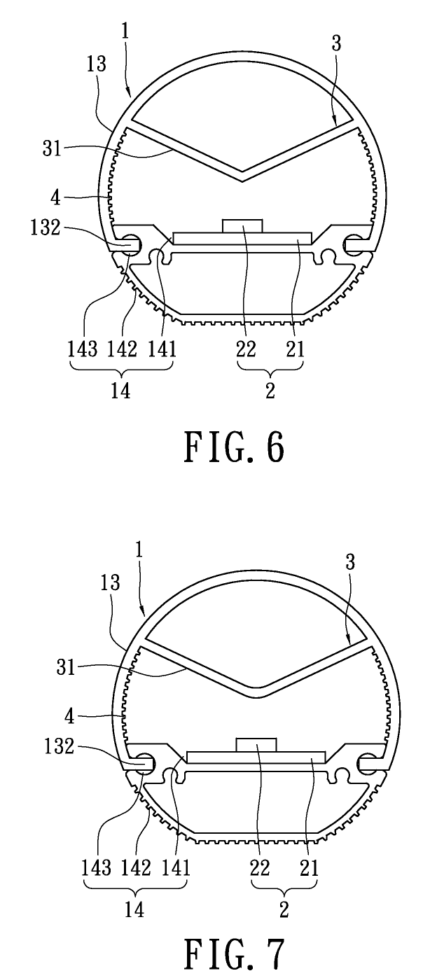

Reference is made to FIG. 6. The difference between this embodiment and the previous embodiment (FIG. 1) is described as followings. The house 1 comprises a light transmitting envelope 13 and a heat dissipating envelope 14. The bottom of the light transmitting envelope 31 has two opposite connecting portions 132. The inner wall of the light transmitting envelope 31 has a plurality of optics microstructures 4. The optics microstructures 4 are shaped into saw teeth. The optics microstructures 4 can be made of light transmitting material, for example the lens, or lenses, which are located between the light emitting unit 2 and the reflector 3. The light source of the light emitting diodes 22 will have refraction via the optics microstructures 4 for blending and diffusing. The heat dissipating envelope 14 is aluminum extrusion shaped, which has a trench 141, a plurality of head dissipating structures 142, and two connecting grooves 143. The trench 141 is located on the top of the heat dissipating envelope 14. The light emitting unit 2 is disposed in the trench 141. The heat dissipating structures 141 are disposed at the bottom of the heat dissipating envelope 14 for dissipating heat rapidly. The two connecting grooves 143 are located at two sides of the heat dissipating envelope 14 for disposing the two connecting portions 132 therein; therefore the light transmitting envelope 13 is assembled with the heat dissipating envelope 14.

Reference is made to FIG. 7. The difference between this embodiment and the previous embodiment (FIG. 6) is described as followings. The reflector 3 has a radian angle at the bend thereof.

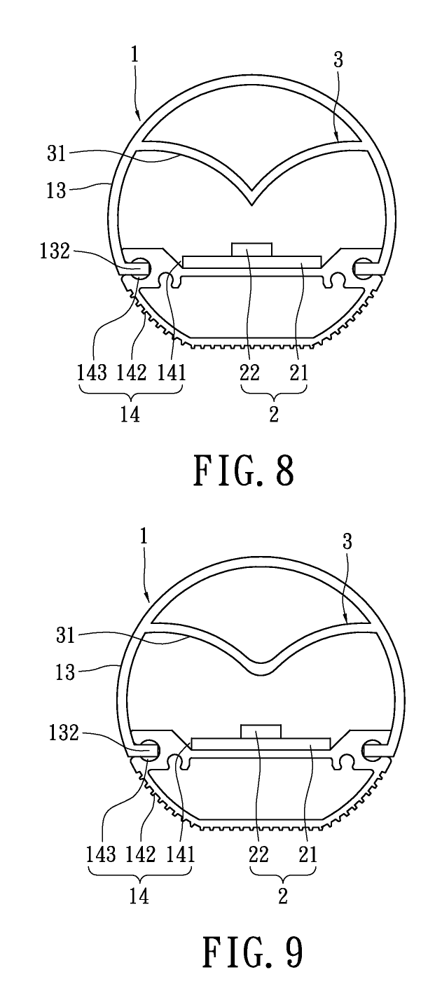

Reference is made to FIG. 8. The difference between this embodiment and the previous embodiment (FIG. 6) is described as followings. The reflecting portion 31 is two arcing surfaces connected to each other, and it has a gull-wing shaped cross section.

Reference is made to FIG. 9. The difference between this embodiment and the previous embodiment (FIG. 8) is described as followings. The reflector 3 has a radian angle at the bend thereof.

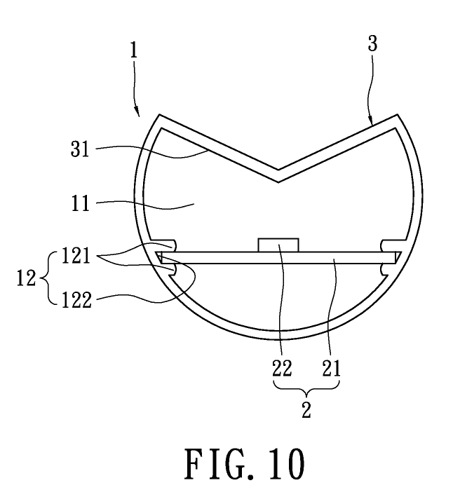

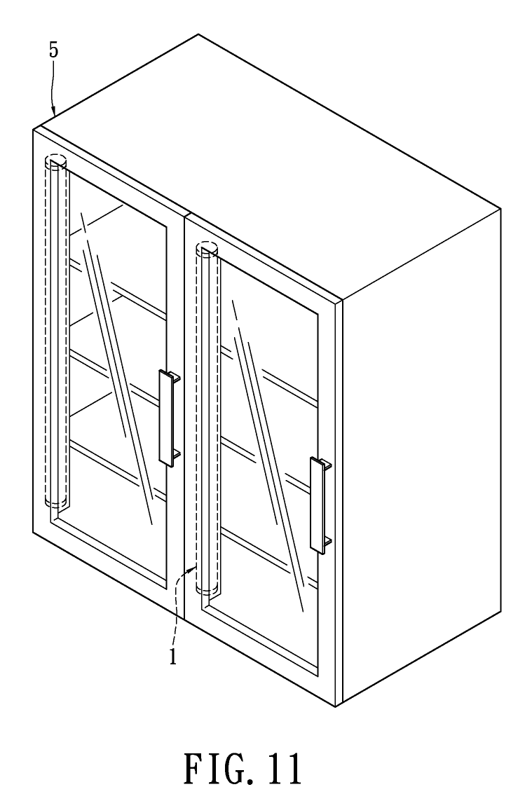

Reference is made to FIG. 10. The difference between this embodiment and the previous embodiment (FIG. 1) is described as followings. A part of the tubular housing 1 above the reflector 3 is taken away to make the reflector 3 bare. The manufacturing material and the cost are saved.

The LED lighting device of the present invention has the following characteristics.

1. The reflector 3 is disposed in the tubular housing 1 and has a wing-shaped reflecting portion 31, which faces the light emitting unit 2 for reflecting the light source emitted from the light emitting diodes 22 to the two lateral directions of the tubular housing 1. Thus, the light source will have specific directions and an efficient use. Compare to the fluorescent lamps, the present invention can increase the brightness instead of using more lamps. The amount of lamps can be reduced.

2. Compare to the fluorescent lamps, the light emitting diodes 22 generate a higher temperature when operating. Thus, the luminous efficiency in the low temperature environment is not reduced. Moreover, there are no burned or broken electrodes. The operating life is longer, and the cost is saved.

3. The inner wall of the light transmitting envelope 13 has a plurality of saw-teeth-shaped optics microstructures

4. The optics microstructures 4 are located between the light emitting unit 2 and the reflector 3. Thus, the light source will be blended and diffused via the optics microstructures 4.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An LED light device, comprising:
a tubular housing having an accommodating space;
a light emitting unit disposed in the accommodating space, wherein the light emitting unit has a plurality of light emitting diodes; and
a reflector disposed in the accommodating space, wherein the reflector has a chevron reflecting portion, the reflecting portion faces the light emitting unit to reflect light emitted from the light emitting diodes to the lateral directions of the tubular housing.

2. The LED light device as claimed in claim 1, wherein the reflector and the tubular housing are formed integrally.

3. The LED light device as claimed in claim 2, wherein the tubular housing are formed via a double material injection molding.

4. The LED light device as claimed in claim 1, wherein the inner wall of the tubular housing has two opposing grooves, and the two ends of the reflector are located in the two opposing grooves.

5. The LED light device as claimed in claim 1, wherein the reflecting portion is a reflecting film attached to the surface of the reflector, and the reflecting surface of the reflector faces the light emitting diodes.

6. The LED light device as claimed in claim 1, wherein the reflecting portion has an angle with 70 to 150 degrees.

7. The LED light device as claimed in claim 1, wherein the reflecting portion is two sloping planes connected to each other, and the reflecting portion has a V-shaped cross section.

8. The LED light device as claimed in claim 1, wherein the reflecting portion is two arcing surfaces connected to each other, and has a gull-wing shaped cross section.

9. The LED light device as claimed in claim 1, wherein the tubular housing is made of plastic.

10. The LED light device as claimed in claim 1, wherein the inner wall of the tubular housing has an accommodating portion, and the light emitting unit is disposed in the accommodating portion.

11. The LED light device as claimed in claim 10, wherein the accommodating portion has four ribs facing protruded disposed on the inner wall of the tubular housing.

12. The LED light device as claimed in claim 10, wherein the light emitting unit comprises an aluminum substrate, the light emitting diodes are disposed on the aluminum substrate, and the two ends of the aluminum substrate are located in the accommodating portion.

13. The LED light device as claimed in claim 10, wherein the accommodating portion comprises two supporting portions and four ribs, the two supporting portions are protruded disposed on the inner wall of the tubular housing, and the four ribs are protruded disposed on the inner wall of the two supporting portions and have a face-to-face arrangement.

14. The LED light device as claimed in claim 1, wherein the tubular housing comprises an light transmitting envelope and a heat dissipating envelope, the light transmitting envelope has two connecting portions, the heat dissipating envelope has a trench and two connecting grooves, the light emitting unit is disposed in the trench, and the two connecting portions are disposed in the two connecting grooves.

15. The LED light device as claimed in claim 14, wherein the inner wall of the light transmitting envelope has a plurality of optics microstructures, and the optics microstructures are located between the light emitting unit and the reflector.

16. The LED light device as claimed in claim 1, wherein the reflector is made of reflecting material plated on the surface of the reflector, and the reflecting surface of the reflector faces the light emitting diodes.
